(19) United States
(12) Patent Application Publication
(10) Pub. No.: US 2008/0244242 A1
(43) Pub. Date: Oct. 2, 2008

(54) Using a Register File as Either a Rename Buffer or an Architected Register File

(76) Inventors: Christopher M. Abernathy, Austin, TX (US); William E. Burky, Austin, TX (US); Joel A. Silberman, Somers, NY (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/695,303

(22) Filed: Apr. 2, 2007

(51) Int. Cl. G06F 7/38

(52) U.S. Cl. 712/225; 712/E09.001

(57) ABSTRACT

A computer implemented method, apparatus, and computer usable program code are provided for implementing a set of architected register files as a set of temporary rename buffers. An instruction dispatch unit receives an instruction that includes instruction data. The instruction dispatch unit determines a thread mode under which a processor is operating. Responsive to determining the thread mode, the instruction dispatch unit determines an ability to use the set of architected register files as the set of temporary rename buffers. Responsive to the ability to use the set of architected register files as the set of temporary rename buffers, the instruction dispatch unit analyzes the instruction to determine an address of an architected register file in the set of architected register files where the instruction data is to be stored. The architected register file operating as a temporary rename buffer stores the instruction data as finished data.

### BACKGROUND

1. Field of the Invention

The present application relates generally to register files. More particularly, the present application relates to a computer implemented method, apparatus, and computer usable program code for using a register file as either a rename buffer or an architected register file.

2. Description of the Related Art

A register file is an array of processor registers in a central processing unit (CPU). Modern integrated circuit-based register files are usually implemented by way of fast static Random Access Memories (RAMs) with multiple ports. Such RAMs are distinguished by having dedicated read and write ports, whereas ordinary multi-ported Static Random Access Memories (SRAMs) will usually read and write through the same port.

The instruction set architecture of a CPU will almost always define a set of registers which are used to stage data between memory and the functional units on the chip. In simpler CPUs, these architectural registers correspond one-for-one to the entries in a physical register file within the CPU. More complicated CPUs use register renaming, so that the mapping of which physical entry stores a particular architectural register changes dynamically during execution.

In out-of-order processors that implement register files that employ a separate rename buffer (RB) and an architected register file (ARF), renamed data is moved from the RB to the ARF upon instruction completion. If a processor supports execution of more than one thread at once, the number of ARF entries in the register file increase to support the architected state. However, register files are limited in their size, in order to meet area, power, and frequency requirements. Therefore, for processors with a large architected register state due to a large number of threads, this may leave little area remaining to implement rename buffers. The number of rename buffer entries should not be too small, however, because they may impose a bottleneck on performance, especially on single-thread performance.

### SUMMARY

The different illustrative embodiments provide a computer implemented method, apparatus, and computer usable program code for implementing a set of architected register files as a set of temporary rename buffers. The illustrative embodiments receive an instruction that includes instruction data. The illustrative embodiments determine a thread mode under which a processor is operating. The illustrative embodiments determine an ability to use the set of architected register files as the set of temporary rename buffers using the determined thread mode in response to determining the thread mode. The illustrative embodiments analyze the instruction to determine an address of a first architected register file in the set of architected register files where the instruction data is to be stored in response to the ability to use the set of architected register files as the set of temporary rename buffers. The illustrative embodiments store the instruction data as finished data in the first architected register file operating as a temporary rename buffer.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, an apparatus is provided. The apparatus may comprise a processor and a memory coupled to the processor. The memory may comprise instructions which, when executed by the processor, cause the processor to perform various ones, and combinations of, the operations outlined above with regard to the method illustrative embodiment.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a data processing system in which the illustrative embodiments may be implemented;

FIG. 2 depicts an exemplary block diagram of a dual threaded processor design showing functional units and registers in accordance with an illustrative embodiment;

FIG. 3 depicts an exemplary implementation of an ARF/RB register file in accordance with an illustrative embodiment;

FIG. 4 is a flowchart for the operation of issuing an instruction in accordance with an illustrative embodiment;

FIG. 5 is a flowchart for the operation of completing an instruction in accordance with an illustrative embodiment; and

FIG. 6 depicts a flowchart for the operation for determining where source data is to be retrieved for instruction execution in accordance with an illustrative embodiment.

### DETAILED DESCRIPTION OF THE PREFERRED EMBODIMENT

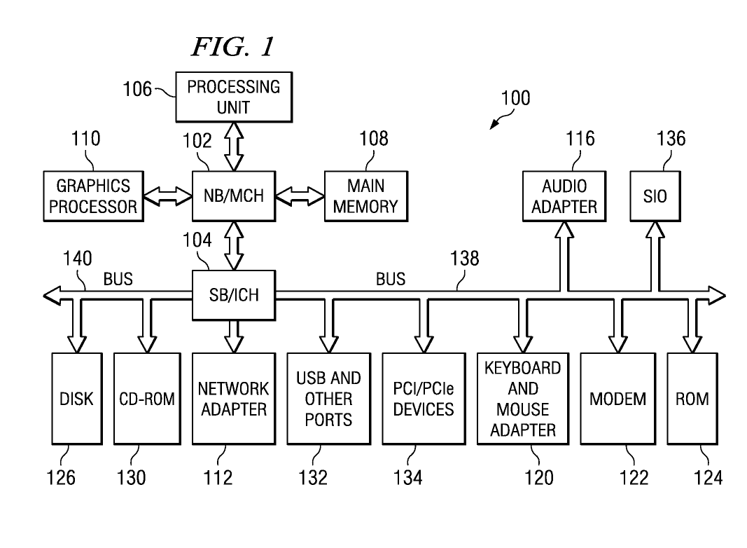

The illustrative embodiments provide for using a register file as either a rename buffer or an architected register file. FIG. 1 is provided as an exemplary diagram of a data processing environment in which embodiments of the present invention may be implemented. It should be appreciated that FIG. 1 is only exemplary and is not intended to assert or imply any limitation with regard to the environments in which aspects or embodiments of the present invention may be implemented. Many modifications to the depicted environments may be made without departing from the spirit and scope of the present invention.

With reference now to FIG. 1, a block diagram of a data processing system is shown in which illustrative embodiments may be implemented. Data processing system 100 is an example of a computer in which computer usable code or instructions implementing the processes may be located for the illustrative embodiments.

In the depicted example, data processing system 100 employs a hub architecture including a north bridge and memory controller hub (MCH) 102 and a south bridge and input/output (I/O) controller hub (ICH) 104. Processing unit 106, main memory 108, and graphics processor 110 are coupled to north bridge and memory controller hub 102. Processing unit 106 may contain one or more processors and even may be implemented using one or more heterogeneous processor systems. Graphics processor 110 may be coupled to the MCH through an accelerated graphics port (AGP), for example.

In the depicted example, local area network (LAN) adapter 112 is coupled to south bridge and I/O controller hub 104 and audio adapter 116, keyboard and mouse adapter 120, modem 122, read only memory (ROM) 124, universal serial bus (USB) ports and other communications ports 132, and PCI/PCIe devices 134 are coupled to south bridge and I/O controller hub 104 through bus 138, and hard disk drive (HDD) 126 and CD-ROM drive 130 are coupled to south bridge and I/O controller hub 104 through bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be coupled to south bridge and I/O controller hub 104.

An operating system runs on processing unit 106 and coordinates and provides control of various components within data processing system 100 in FIG. 1. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 100. Java and all Java-based trademarks are trademarks of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processing unit 106. The processes of the illustrative embodiments may be performed by processing unit 106 using computer implemented instructions, which may be located in a memory such as, for example, main memory 108, read only memory 124, or in one or more peripheral devices.

The hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system.

In some illustrative examples, data processing system 100 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted examples in FIG. 1 and above-described examples are not meant to imply architectural limitations. For example, data processing system 100 also may be a tablet computer, laptop computer, or telephone device in addition to taking the form of a PDA.

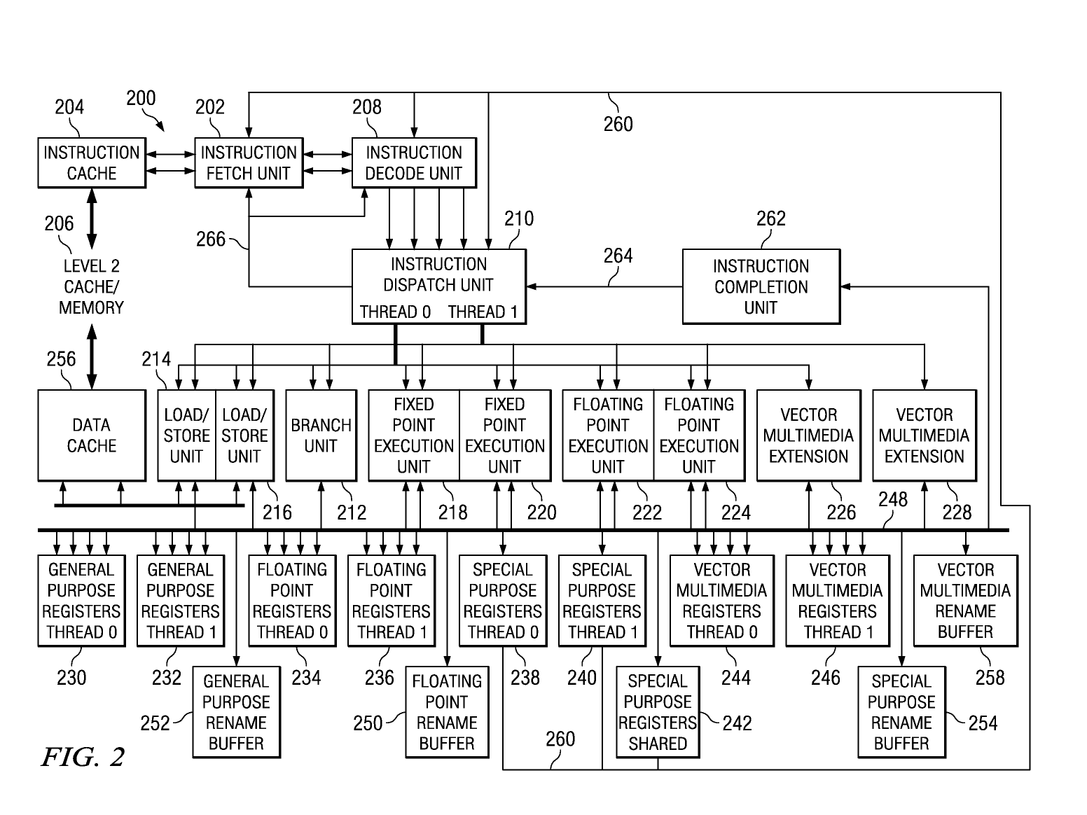

Referring to FIG. 2, an exemplary block diagram of a conventional dual threaded processor design showing functional units and registers. Processor 200 may be implemented as processing unit 102 in FIG. 1 in these illustrative examples. Processor 200 comprises a single integrated circuit superscalar microprocessor with dual-thread simultaneous multi-threading (SMT). Accordingly, as discussed further herein below, processor 200 includes various units, registers, buffers, memories, and other sections, all of which are formed by integrated circuitry. Also, in an illustrative embodiment, processor 200 operates according to reduced instruction set computer (RISC) techniques.

As shown in FIG. 2, instruction fetch unit (IFU) 202 connects to instruction cache 204. Instruction cache 204 holds instructions for multiple programs (threads) to be executed. Instruction cache 204 also has an interface to level 2 (L2) cache/memory 206. IFU 202 requests instructions from instruction cache 204 according to an instruction address, and passes instructions to instruction decode unit 208. In an illustrative embodiment, IFU 202 can request multiple instructions from instruction cache 204 for up to two threads at the same time. Instruction decode unit 208 decodes multiple instructions for up to two threads at the same time and passes decoded instructions to instruction dispatch unit (IDU) 210. IDU 210 selectively groups decoded instructions from instruction decode unit 208 for each thread, and outputs or issues a group of instructions for each thread to execution units 212, 214, 216, 218, 220, 222, 224, 226, and 228 of the processor.

In an illustrative embodiment, the execution units of the processor may include branch unit 212, load/store units (LSUA) 214 and (LSUB) 216, fixed-point execution units (FXUA) 218 and (FXUB) 220, floating-point execution units (FPUA) 222 and (FPUB) 224, and vector multimedia extension units (VMXA) 226 and (VMXB) 228. Execution units 212, 214, 216, 218, 220, 222, 224, 226, and 228 are fully shared across both threads, meaning that execution units 212, 214, 216, 218, 220, 222, 224, 226, and 228 may receive instructions from either or both threads. The processor includes multiple register sets 230, 232, 234, 236, 238, 240, 242, 244, and 246, which may also be referred to as architected register files (ARFs).

An ARF is a file where completed data is stored once an instruction has completed execution. ARFs 230, 232, 234, 236, 238, 240, 242, 244, and 246 may store data separately for each of the two threads and by the type of instruction, namely general purpose registers (GPR) 230 and 232, floating-point registers (FPR ) 234 and 236, special purpose registers (SPR) 238 and 240 and vector registers (VR) 244 and 246. Separately storing completed data by type and by thread assists in reducing processor contention while processing instructions.

The processor additionally includes a set of special purpose registers (SPR) 242 for holding program states, such as an instruction pointer, stack pointer, or processor status word, which may be used on instructions from either or both threads. Simplified internal bus structure 248 depicts connections between execution units 212, 214, 216, 218, 220, 222, 224, 226, and 228 and ARFs 230, 232, 234, 236, 238, 240, 242, 244, and 246.

In order to execute a floating-point instruction, FPUA 222 and FPUB 224 retrieves register source operand information, which is input data required to execute an instruction, from FPRs 234 and 236, if the instruction data required to execute the instruction is complete, or from floating-point rename buffer 250, if the instruction data is not complete. Complete data is data that has been generated by an execution unit once an instruction has completed execution and is stored in an ARF, such as ARFs 230, 232, 234, 236, 238, 240, 242, 244, and 246. Incomplete data is data that has been generated during instruction execution where the instruction has not completed execution. Incomplete data is stored on rename buffers, such as rename buffer 250, 252, 254, or 258. FPUA 222 and FPUB 224 input their data according to which thread each executing instruction belongs to. For example, FPUA 222 inputs completed data to FPR 234 and FPUB 224 inputs completed data to FPR 236, because FPUA 222 and FPUB 224 and FPRs 234 and 236 are thread specific.

During execution of an instruction, FPUA 222 and FPUB 224 output their destination register operand data, or instruction data generated during execution of the instruction, to floating-point rename buffer 250. The instruction data is later sent to FPRs 234 and 236 when the instruction has completed execution, according to which thread each executing instruction belongs to. In order to execute an instruction, FXUA 218, FXUB 220, LSUA 214, and LSUB 216 retrieve register source operand information from GPRs 230 and 232, if data is complete or from rename buffer 252, if the data is not completed yet. During execution of an instruction, FXUA 218, FXUB 220, LSUA 214, and LSUB 216 output their destination register operand data to rename buffer 252, which is later sent to GPRs 230 and 232 at completion time according to which thread each executing instruction belongs to.

In order to execute some subset of instructions, such as those instructions requiring program states, executed by FXUA 218, FXUB 220, and branch unit 212 use SPRs 238, 240, and 242 as source and destination operand registers when data is complete or use special purpose rename buffer 254 as source and destination operand registers, if the data is not completed yet. During execution of an instruction, FXUA 218, FXUB 220, and branch unit 212 output their destination register operand data to special purpose rename buffer 254, which is later sent to SPRs 238, 240, and 242 at completion time according to which thread each executing instruction belongs to. LSUA 214 and LSUB 216 input their storage operands from and output their storage operands to data cache 256 which stores operand data for multiple programs (threads). In order to execute an instruction, VMXA 226 and VMXB 228 input their register source operand information from VRs 244 and 246, if data is complete, according to which thread each executing instruction belongs to, or from vector multimedia rename buffer 258, if the data is not completed yet. During execution of an instruction, VMXA 226 and VMXB 228 output their destination register operand data to vector multimedia rename buffer 258, which is later sent to VRs 244 and 246 at completion time according to which thread each executing instruction belongs to. Data cache 256 also has an interface to level 2 cache/memory 206.

Data cache 256 may also have associated with it a non-cacheable unit (not shown) which accepts data from the processor and writes it directly to level 2 cache/memory 206, thus bypassing the coherency protocols required for storage to cache.

In response to the instructions input from instruction cache 204 and decoded by instruction decode unit 208, IDU 210 selectively dispatches the instructions to execution units 212, 214, 216, 218, 220, 222, 224, 226, and 228 with regard to instruction type and thread. In turn, execution units 212, 214, 216, 218, 220, 222, 224, 226, and 228 execute one or more instructions of a particular class or type of instructions. For example, FXUA 218 and FXUB 220 execute fixed-point mathematical operations on register source operands, such as addition, subtraction, ANDing, ORing and XORing. FPUA 222 and FPUB 224 execute floating-point mathematical operations on register source operands, such as floating-point multiplication and division. LSUA 214 and LSUB 216 execute load and store instructions, which move operand data between data cache 256 and ARFs 230, 232, 234, and 236. VMXA 226 and VMXB 228 execute single instruction operations that include multiple data. Branch unit 212 executes branch instructions which conditionally alter the flow of execution through a program by modifying the instruction address used by IFU 202 to request instructions from instruction cache 204.

IDU 210 groups together instructions that are decoded by instruction decode unit 208 to be executed at the same time, depending on the mix of decoded instructions and available execution units 212, 214, 216, 218, 220, 222, 224, 226, and 228 to perform the required operation for each instruction. For example, because there are only two load/store units 214 and 216, a maximum of two load/store type instructions may be grouped together. In an illustrative embodiment, up to seven instructions may be grouped together (two fixed-point arithmetic, two load/store, two floating-point arithmetic (FPU) or two vector multimedia extension (VMX), and one branch), and up to five instructions may belong to the same thread. IDU 210 includes in the group as many instructions as possible from the higher priority thread, up to five, before including instructions from the lower priority thread. Thread priority is determined by the thread's priority value and the priority class of its process. The processing system uses the base priority level of all executable threads to determine which thread gets the next slice of processor time. Threads are scheduled in a round-robin fashion at each priority level, and only when there are no executable threads at a higher level does scheduling of threads at a lower level take place.

However, IDU 210 dispatches either FPU instructions 222 and 224 or VMX instructions 226 and 228 in the same group with FXU instructions 218 and 220. That is, IDU 210 does not dispatch FPU instructions 222 and 224 and VMX instructions 226 and 228 in the same group. Program states, such as an instruction pointer, stack pointer, or processor status word, stored in SPRs 238 and 240 indicate thread priority 260 to IDU 210.

Instruction completion unit 262 monitors internal bus structure 248 to determine when instructions executing in execution units 212, 214, 216, 218, 220, 222, 224, 226, and 228 are finished writing their operand results to rename buffers 250, 252, 254, or 258. Instructions executed by branch unit 212, FXUA 218, FXUB 220, LSUA 214, and LSUB 216 require the same number of cycles to execute, while instructions executed by FPUA 222, FPUB 224, VMXA 226, and VMXB 228 require a variable, and a larger number of cycles to execute. Therefore, instructions that are grouped together and start executing at the same time do not necessarily finish executing at the same time. “Completion” of an instruction means that the instruction is finishing executing in one of execution units 212, 214, 216, 218, 220, 222, 224, 226, or 228 and all older instructions have already been updated in the architected state, since instructions have to be completed in order. Hence, the instruction is now ready to complete and update the architected state, which means updating the final state of the data as the instruction has been completed. The architected state can only be updated in order, that is, instructions have to be completed in order and the completed data has to be updated as each instruction completes.

Instruction completion unit 262 monitors for the completion of instructions, and sends control information 264 to IDU 210 to notify IDU 210 that more groups of instructions can be dispatched to execution units 212, 214, 216, 218, 220, 222, 224, 226, and 228. IDU 210 sends dispatch signal 266, which serves as a throttle to bring more instructions down the pipeline to the dispatch unit, to IFU 202 and instruction decode unit 208 to indicate that it is ready to receive more decoded instructions. Processor 200 also employs rename buffers 250, 252, 254, and 258 in order to support data movement. Rename buffers 250, 252, 254, and 258 may also be referred to as rename registers or reorder buffers. Rename buffers 250, 252, 254, and 258 contain: i) data for in-flight instructions, which are instructions that have been sent from the dispatch unit, but have not finished yet); or ii) non-architected data, which is data that has finished, or been produced by the execution units, but has not completed and been placed into the ARF yet, that is written over internal bus structure 248. Register results from execution units 212, 214, 216, 218, 220, 222, 224, 226, and 228 are held in rename buffers 250, 252, 254, and 258 according to which execution unit the associated instruction belongs to. While the illustrative embodiments indicate that there is one rename buffer for each of ARF 230, 232, 234, 236, 238, 240, 242, 244, and 246, one of ordinary skill in the art would understand that any configuration may be employed for associating rename buffers to register sets.

As stated earlier, in out-of-order processors, such as processor 200, that implement register files which employ separate rename buffers (RBs), such as rename buffers 250, 252, 254, and 258, and ARFs, such as ARFs 230, 232, 234, 236, 238, 240, 242, 244, and 246, renamed data, which is data that is non-architected data and stored in the RB, is moved from the RB to the ARF upon instruction completion. As processor 200 supports execution of more than one thread at once, the number of ARF entries in register files 230, 232, 234, 236, 238, 240, 242, 244, and 246 must also increase to support the architected state. ARFs 230, 232, 234, 236, 238, 240, 242, 244, and 246 are limited in their size, in order to meet area, power, and frequency requirements. Therefore, for processors, such as processor 200, with a large architected register state due to a large number of threads, this may leave little area remaining to implement many rename buffers, such as rename buffers 250, 252, 254, and 258.

In order to minimize or reduce the rename buffer size bottleneck for processors that support execution of a large number of threads at once, the illustrative embodiments use ARFs, such as ARFs 230, 232, 234, 236, 238, 240, 242, 244, and 246, as rename buffers when the ARF for a given thread is disabled. An ARF may be disabled when the thread for the given ARF is not in use. The illustrative embodiments refer to an ARF used as a rename buffer as an ARF/RB register file.

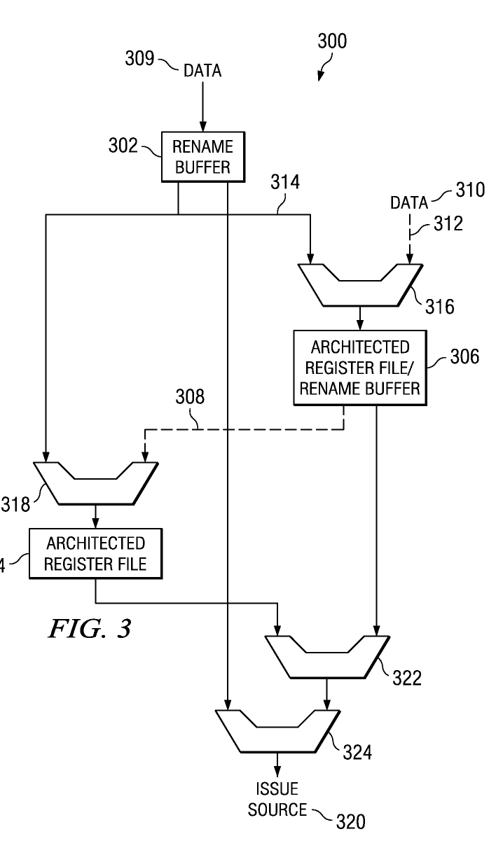

FIG. 3 depicts an exemplary implementation of a storage system in accordance with an illustrative embodiment. Storage system 300 comprises rename buffer 302, architected register file (ARF) 304, and architected register file/rename buffer (ARF/RB) 306. Rename buffer 302 may be rename buffer 250, 252, 254, or 258 of FIG. 2. ARF 304 may be ARF 230, 232, 234, 236, 238, 240, 242, 244, or 246 of FIG. 2. If the thread associated with ARF/RB 306, which may also be referred to as a multiuse register, is not being used (disabled) by the processor, the processor configures ARF/RB 306 as a rename buffer. If the thread associated with ARF/RB 306 is being used (enabled), the processor configures ARF/RB 306 as an architected register file.

In order to implement ARF/RB 306 as a rename buffer when the processor has the second thread disabled, storage system 300 includes read port 308 that connects ARF/RB 306 to multiplex port 318, in order to support data movement to ARF 304 upon instruction completion. An execution unit may send instruction data 310 to ARF/RB 306 via write port 312 through multiplex port 316 as finished data in addition to instruction data 309 being sent from rename buffer 302 to ARF/RB 306 via write port 314 as completed data. Finished data is output data produced by the execution units as opposed to completed data that is data in its final state after the instruction has completed executing. Write port 314 is not used for sending finished data to ARF/RB 306 when the processor enables the second thread. Therefore, when the second thread is enabled and ARF/RB 306 is being used as an ARF, finished data is written to RB 302 and completed data is sent to ARF/RB 306 or ARF 304 via write port 314.

Execution units distinguish between writing either rename buffer 302 or ARF/RB 306 using the data write address included in the instruction. The processor may be configured such that the most significant bit (MSB) of the data write address may be used to distinguish either the rename buffer 302 or ARF/RB 306. Storage system 300 includes multiplex port 318 as input to architected register file 304 so that completed data may be retrieved from rename buffer 302 or ARF/RB 306. The instruction completion unit retrieves completed data from ARF/RB 306 if the processor disables the thread associated with ARF/RB 306, thus configuring ARF/RB 306 as a rename buffer, and the completion data address is such that the completion data address points to ARF/RB 306 rather than rename buffer 302. The location of where the data is stored may be located in a global completion table (GCT) that is referred to in order to retrieve data for completion.

For a single thread mode, issue source 320 only reads data from the architected register file/rename buffer 306 when the thread associated with architected register file/rename buffer 306 is disabled and the instruction has not yet completed, that is, the data is still in rename buffer 302 or ARF/RB 306. When both threads are enabled, the instruction completion unit reads ARF/RB 306 when the data is already completed. In single thread mode, multiplex port 322 combines data from architected register file 304 and ARF/RB 306 if the data has not yet completed. When both threads are enabled, multiplex port 322 combines data from architected register file 304 and ARF/RB 306 if the data has been completed, depending on the thread of the issued instruction. Multiplex port 324 combines data from rename buffer 302 and multiplex port 322 if the data is complete in dual-thread mode or, if based upon the source data address which tells whether the data is in the RB or the ARF/RB in single thread mode.

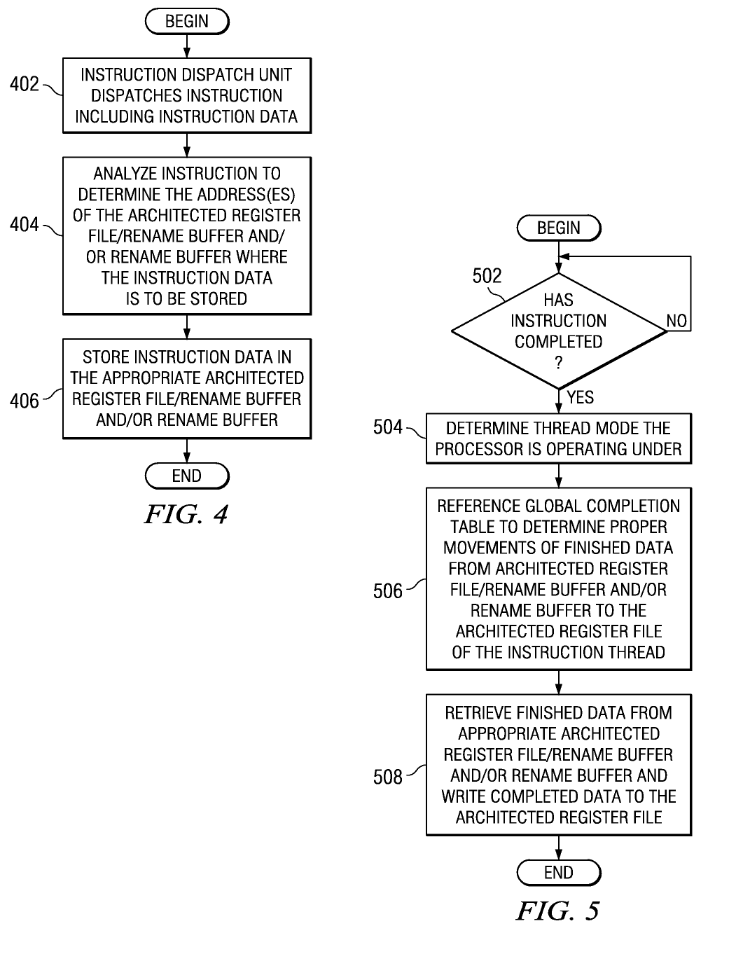

FIG. 4 is a flowchart for the operation of issuing an instruction in accordance with an illustrative embodiment. The following description uses an instruction dispatch unit to perform the operations. However, the operation may be performed by other units within a processor, such as an instruction decode unit e.g., instruction decode unit 208 of FIG. 2. As the operation begins, an instruction dispatch unit, such as instruction dispatch unit 210 of FIG. 2, dispatches an instruction that includes instruction data (step 402). The instruction dispatch unit analyzes the instruction to determine the address of the rename buffer, such as rename buffer 302, and/or the architected register file/rename buffer, such as architected register file/rename buffer 306, where the instruction data is to be stored (step 404). The appropriate rename buffer and/or ARF/RB stores the instruction data (step 406), with the operation terminating thereafter. The instruction data remains in the rename buffer and/or ARF/RB until the instruction is completed, upon which the instruction completion unit moves the completed data to the architected register file.

FIG. 5 is a flowchart for the operation of completing an instruction in accordance with an illustrative embodiment. As the operation begins, the instruction completion unit, such as instruction completion unit 262 of FIG. 2, determines if the instruction has completed (step 502). At step 502, if the instruction has not completed executing, the operation returns to step 502 until the instruction completes execution. At step 502, if the instruction completion unit determines that the instruction has completed, then the instruction completion unit determines the thread mode the processor is operating under (step 504). The instruction completion unit uses the thread mode to reference a global completion table to determine the proper movements of finished data from rename buffer and/or ARF/RB to the ARF of the instruction thread (step 506). The instruction completion unit then retrieves finished data from appropriate rename buffer and/or ARF/RB and writes the completed data to the architected register file of the instruction thread (step 508), with the operation terminating thereafter.

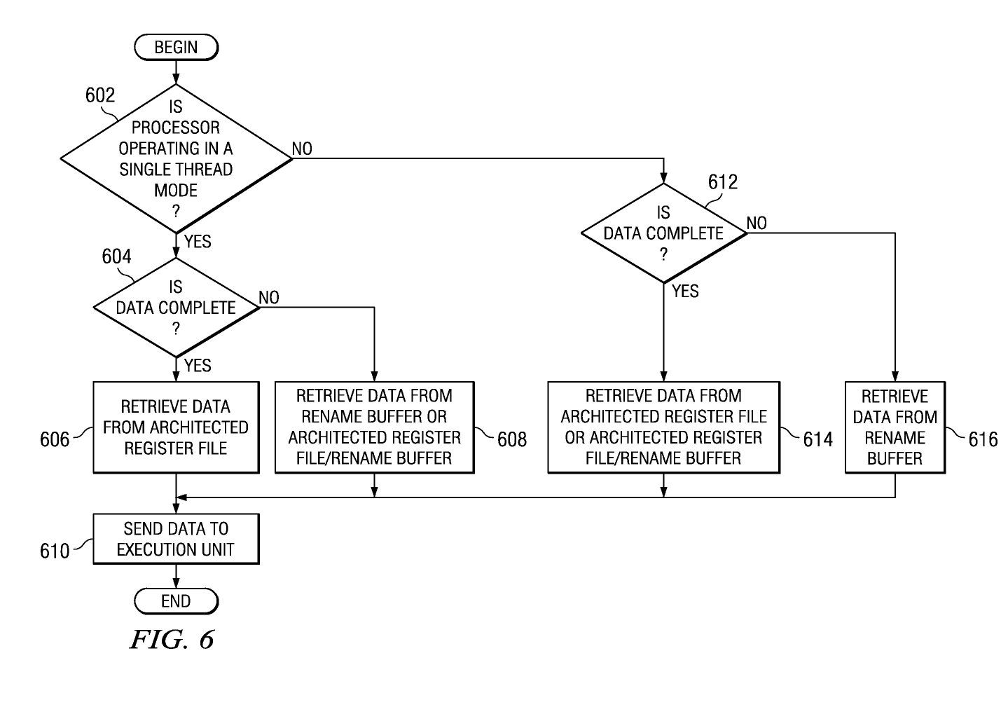

FIG. 6 depicts a flowchart for the operation for determining where source data is to be retrieved for instruction execution in accordance with an illustrative embodiment. As the operation begins, the instruction dispatch unit, such as instruction dispatch unit 210 of FIG. 2, determines if the processor is operating in a single thread mode (step 602). If at step 602 the processor is operating in a single thread mode, the instruction dispatch unit determines if the data has completed (step 604). If at step 604 the data has completed, the instruction dispatch unit retrieves the data from an architected register file, such as architected register file 304 of FIG. 3 (step 606). If at step 604 the data has not yet completed, the instruction dispatch unit retrieves the data from either a rename buffer, such as rename buffer 302 of FIG. 3 or from an architected register file/rename buffer, such as architected register file/rename buffer 306 of FIG. 3, depending on the address of the data (step 608). After either step 606 or 608, the instruction dispatch unit sends the data to the execution unit (step 610), with the operation ending thereafter.

Returning to step 602, if the processor is not operating in a single thread mode, the instruction dispatch unit determines if the data has completed (step 612). If at step 612 the data has completed, the instruction dispatch unit retrieves the data from either an architected register file, such as architected register file 304 of FIG. 3, or from an ARF/RB, such as ARF/RB 306 of FIG. 3, depending on the thread of the data (step 614). If at step 612 the data has not yet completed, then the instruction dispatch unit retrieves the data from a rename buffer, such as rename buffer 302 of FIG. 3, (step 616). After either step 614 or 616, the instruction dispatch unit sends the data to the execution unit (step 610), with the operation ending thereafter.

Thus, the illustrative embodiments provide for implementing a set of register files as rename buffers. An instruction is received that includes instruction data. The instruction is analyzed to determine the address of a register file in the set of register files where the instruction data is to be stored. Finally, the instruction data is stored as finished data in the register file.

The illustrative embodiments can take the form of an entirely hardware embodiment, an entirely software embodiment or an embodiment containing both hardware and software elements. The illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for implementing a set of architected register files as a set of temporary rename buffers, the computer implemented method comprising:
receiving an instruction that includes instruction data;
determining a thread mode under which a processor is operating;
responsive to determining the thread mode, determining an ability to use the set of architected register files as the set of temporary rename buffers using the determined thread mode;
responsive to the ability to use the set of architected register files as the set of temporary rename buffers, analyzing the instruction to determine an address of a first architected register file in the set of architected register files where the instruction data is to be stored; and
storing the instruction data as finished data in the first architected register file operating as a temporary rename buffer.

2. The computer implemented method of claim 1, further comprising:
using the determined thread mode, determining a location of the finished data in the set of architected register files;
retrieving the finished data from the located architected register file; and
writing the finished data from the located architected register file to a second architected register file in the set of architected register files as completed data.

3. The computer implemented method of claim 1, further comprising:
responsive to the inability to use the set of architected register files as the set of temporary rename buffers, determining if the instruction is issuing for execution;
responsive to the instruction issuing for execution, determining if the finished data has been written as completed data;
responsive to an absence of the completed data, retrieving the finished data from a set of rename buffers;
responsive to an existence of the completed data, retrieving the completed data from one of the set of architected register files where the completed data is located; and
executing the instruction using the finished data and the completed data.

4. The computer implemented method of claim 3, further comprising:
responsive to the ability to use the set of architected register files as the set of temporary rename buffers, determining if the finished data has been written as the completed data;
responsive to the absence of the completed data, retrieving the finished data from the first architected register file or the set of rename buffers;
responsive to the existence of the completed data, retrieving the completed data from one of the set of architected register files where the completed data is located; and
executing the instruction using the finished data and the completed data.

5. The computer implemented method of claim 1, wherein the set of architected register files operates as the set of temporary rename buffers when the thread associated with the specific architected register file is disabled.

6. The computer implemented method of claim 1, wherein the set of architected register files operates as actual architected register files when the thread associated with the architected register file is enabled.

7. The computer implemented method of claim 1, further comprising:
providing a connection from the first architected register file to a second architected register file.

8. The computer implemented method of claim 2, further comprises:
providing a multiplex port coupled to the second architected register file that receives data from the set of temporary rename buffers and the first architected register file.

9. The computer implemented method of claim 1, further comprises:
providing a multiplex port coupled to the first architected register file that receives data from the set of temporary rename buffers and a write port.

10. A apparatus comprising:
a processing unit;
a set of architected register files coupled to the processing unit, wherein the processing unit executes the set of instructions to:
receive an instruction that includes instruction data;
determine a thread mode under which the processing unit is operating;
determine an ability to use the set of architected register files as a set of temporary rename buffers using the determined thread mode in response to determining the thread mode;
analyze the instruction to determine an address of a first architected register file in the set of architected register files where the instruction data is to be stored in response to the ability to use the set of architected register files as the set of temporary rename buffers; and
store the instruction data as finished data in the first architected register file operating as a temporary rename buffer.

11. The apparatus of claim 10, wherein the processing unit executes the set of instructions to:
using the determined thread mode, determine a location of the finished data in the set of architected register files;
retrieve the finished data from the located architected register file; and
write the finished data from the located architected register file to a second architected register file in the set of architected register files as completed data.

12. The apparatus of claim 10, wherein the processing unit executes the set of instructions to:
determine if the instruction is issuing for execution in response to the inability to use the set of architected register files as the set of temporary rename buffers;
determine if the finished data has been written as completed data in response to the instruction issuing for execution;
retrieve the finished data from a set of rename buffers in response to an absence of the completed data;
retrieve the completed data from one of the set of architected register files where the completed data is located in response to an existence of the completed data; and
execute the instruction using the finished data and the completed data.

13. The apparatus of claim 12, wherein the processing unit executes the set of instructions to:
determine if the finished data has been written as the completed data in response to the ability to use the set of architected register files as the set of temporary rename buffers;
retrieve the finished data from the first architected register file or the set of rename buffers in response to the absence of the completed data;
retrieve the completed data from one of the set of architected register files where the completed data is located in response to the existence of the completed data; and
execute the instruction using the finished data and the completed data.

14. The apparatus of claim 10, wherein the set of architected register files operates as the set of temporary rename buffers when the thread associated with the specific architected register file is disabled and wherein the set of architected register files operates as actual architected register files when the thread associated with the architected register file is enabled.

15. The apparatus of claim 10, further comprising:
a first multiplex port coupled to the second architected register file that receives data from the set of rename buffers and the first architected register file;
a connection from the first architected register file to the second multiplex port; and
a second multiplex port coupled to the first architected register file that receives data from the set of temporary rename buffers and a write port.

16. A computer program product comprising:
a computer usable medium including computer usable program code for implementing a set of architected register files as a set of temporary rename buffers, the computer program product including:
computer usable program code for receiving an instruction that includes instruction data;
computer usable program code for determining a thread mode under which a processor is operating;
computer usable program code for determining an ability to use the set of architected register files as the set of temporary rename buffers using the determined thread mode in response to determining the thread mode;
computer usable program code for analyzing the instruction to determine an address of a first architected register file in the set of architected register files where the instruction data is to be stored in response to the ability to use the set of architected register files as the set of temporary rename buffers; and
computer usable program code for storing the instruction data as finished data in the first architected register file operating as a temporary rename buffer.

17. The computer program product of claim 16, further including:
computer usable program code for, using the determined thread mode, determining a location of the finished data in the set of architected register files;
computer usable program code for retrieving the finished data from the located architected register file; and
computer usable program code for writing the finished data from the located architected register file to a second architected register file in the set of architected register files as completed data.

18. The computer program product of claim 16, further including:
computer usable program code for determining if the instruction is issuing for execution in response to the inability to use the set of architected register files as the set of temporary rename buffers;
computer usable program code for determining if the finished data has been written as completed data in response to the instruction issuing for execution;
computer usable program code for retrieving the finished data from a set of rename buffers in response to an absence of the completed data;
computer usable program code for retrieving the completed data from one of the set of architected register files where the completed data is located in response to an existence of the completed data; and
computer usable program code for executing the instruction using the finished data and the completed data.

19. The computer program product of claim 18, further including:
computer usable program code for determining if the finished data has been written as the completed data in response to the ability to use the set of architected register files as the set of temporary rename buffers;
computer usable program code for retrieving the finished data from the first architected register file or the set of rename buffers in response to the absence of the completed data;
computer usable program code for retrieving the completed data from one of the set of architected register files where the completed data is located in response to the existence of the completed data; and
computer usable program code for executing the instruction using the finished data and the completed data.

20. The computer program product of claim 16, wherein the set of architected register files operates as the set of temporary rename buffers when the thread associated with the specific architected register file is disabled and wherein the set of architected register files operates as actual architected register files when the thread associated with the architected register file is enabled.
